(19) United States
(12) Patent Application Publication
(10) Pub. No.: US 2023/0313057 A1
(43) Pub. Date: Oct. 5, 2023

(54) SCALE INHIBITING METHOD WITH PHOSPHATED NATURAL OILS

(71) Applicant: Ohio Soybean Council, Worthington, OH (US)

(72) Inventors: Robert J. Cain, Lewis Center, OH (US); Dylan Karis, Lewis Center, OH (US)

(21) Appl. No.: 18/192,502

(22) Filed: Mar. 29, 2023

Related U.S. Application Data
(60) Provisional application No. 63/362,169, filed on Mar. 30, 2022.

(51) Int. Cl. C10G 75/00; C11C 3/00

(52) U.S. Cl. CPC C10G 75/00; C11C 3/00

(57) ABSTRACT

Methods of applying a triglyceride-based oil phosphate with ability to reduce or prevent scale development are described. Scale development may occur in formations, casings, valves, pipes, and pumps around an oil producing wellbores, or water systems involving swamp coolers, evaporators, heating systems, and steam generators. Scale reducing compositions and methods of making them are also described.

### RELATED APPLICATIONS

This application claims priority to U.S. Provisional Patent Application Ser. No. 63/362,169 filed on Mar. 30, 2023, the entirety of which is incorporated herein by reference.

### BACKGROUND

Scale inhibitors are used in the oil industry where the precipitation of mineral deposits or scale formation can block or hinder flow through pipelines and pumps. Scale inhibitors are chemicals that prevent or slow the precipitation of scales, in particular inorganic scales or mineral deposits formed from calcium, barium, or magnesium or other minerals in formation water mix with different brines in injection water. Changes in pH, pressure, temperature, and combinations of dissolved mineral ions from insoluble compounds can result in scale formation. Typical scale inhibitor structures are a polymeric carboxylic acids, sulfonates, phosphonate or phosphates. One cost effective way to manage scale is referred to as a “threshold effect.” This method involves adding a small amount of inhibitor, compared to the mineral content, which is sufficient to sequester scale precipitation.

Phosphorated oils and the method of preparing them are known, and they have been used for applications in urethanes and oil additives. The method of phosphorating epoxidized triglycerides is described in U.S. Pat. No. 2,965,657. This teaches that an epoxidized oil dissolved in solvent can simply be combined with phosphoric acid to create a hydroxylated phosphorated triglyceride, with the solvent being removed by boiling. The structure formed is shown below.

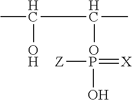

wherein X is from the group S and O and Z is —H, —OH, —OP═O(OH), I—OP═O(OH)3OH; alkyloxy, aryl oxy, alkyl, or aryl. An alkali metal, metal hydroxide, or amines can then be introduced to make the oil a water-soluble salt.

U.S. Pat. No. 8,822,712 describes a similar reaction product formed with the use of catalysts. The product is used as for an oil soluble additive.

Patent EP 1976805B1 teaches a polyphosphonate metal salt used as an antiscaling agent. This is of a polymeric repeating form.

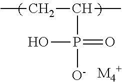

U.S. Pat. No. 7,241,391 claims a biobased scale inhibitor prepared with soy proteins and gluconic acids.

US Publication No. 2011/0049052 mentions alkylene oxides of natural oils for use in scale inhibition of silicates.

In addition, there are a number of literature papers describing hydroxylated phosphorated triglycerides, such as the one described in U.S. Pat. No. 2,965,657 and its use as a polyol. The advantage in urethane foam preparation would be due to phosphorous inherent flame resistance and ability to induced charring and inhibit flame propagation. See, for example: Physical properties of soy-phosphate polyol-based rigid polyurethane foams, Fan, Fiongyu; Tekeei, Ali; Suppes, Galen J.; Hsieh, Fu-Hung, International Journal of Polymer Science 907049, 8 pp.; Novel Biobased Polyurethanes Synthesized from Soybean Phosphate Ester Polyols: Thermomechanical Properties Evaluations, Dwan'Isa, J.-P. Latere; Mohanty, A. K.; Misra, M.; Drzal, L. T.; Kazemizadeh, M., Journal of Polymers and the Environment Volume 11 Issue 4 Pages 161-168; The structure is also mentioned in Hydrolysis of Epoxidized Soybean Oil in the Presence of Phosphoric Acid, Yinzhong Guo et al. , J Am Oil Chem Soc (2007) 84:929-935.

There remains a need for improved scale reduction in oilfield hydraulic fluid.

### DETAILED DESCRIPTION

The present application provides a scale inhibiting composition, a method of making the scale inhibiting composition, and a method of reducing scale using the scale inhibiting composition. The scale inhibiting composition is based on plant and animal oils, making it environmentally friendly.

The top uses of oilfield hydraulic fluids are drilling muds, secondary recovery, tertiary recovery or enhanced recovery, and fracking fluids. Drilling muds are used to aid the drilling of boreholes by driving the bit, suspending and carrying away drill cuttings, stabilizing the bore, sealing pores in the bore, maintaining pressure, keeping the drill bit cool, and keep formation fluid from entering the wellbore. Secondary and tertiary oil recovery involves pushing the oil out with fluid or gas, sometimes with water or surfactants. Fracking fluids crack the formation hydraulically with pressure to allow easier oil or gas recovery.

Plant and animal oils are abundant natural resources that are cheap and readily available. The triglyceride is composed of a mixture of saturated and unsaturated fatty acids. For use in the present application, the points of unsaturation have been transformed into epoxides.

Any suitable plant or animal oils can be used. Suitable plant and animal oils include, but are not limited to, soybean oil, palm oil, olive oil, corn oil, canola oil, coconut oil, cottonseed oil, cashew nutshell liquid, palm kernal oil, rice bran oil, safflower oil, sesame oil, hemp oil, lard, tallow, fish oil, algal oil, and combinations thereof.

One aspect is a scale inhibiting composition. In one embodiment, the scale inhibiting composition comprises: the reaction product of an epoxidized natural oil and phosphoric acid, the reaction product having 3 or more phosphorous ester groups per molecule.

In some embodiments, the salt of the reaction product has 4 or more phosphorous esters per molecule.

In some embodiments, the reaction product is neutralized forming a salt of the reaction product which is water-soluble. The salt of the reaction product comprises a water-soluble natural oil phosphate salt.

In some embodiments, the counterion of the natural oil phosphate salt comprises sodium, potassium, primary amines, secondary amines, or tertiary amines. The use of amine salts is desirable. Suitable amines include, but are not limited to, ethanolamine, diethanolamine, diethylenetriamine, triethanolamine, triethylenetetramine, amidoamines, imidazolines. The amine may have secondary characteristics as a corrosion inhibitor.

Another aspect is a method of making a scale inhibiting composition. In one embodiment, the method comprises: reacting an epoxidized natural oil with an oxirane oxygen value between 1-10% with phosphoric acid to form a hydroxyphosphoric ester.

The epoxide rings on the natural oil are opened with phosphoric acid to yield a hydroxyl and a phosphate ester.

In some embodiments, the hydroxyphosphoric ester is neutralized with a base to form a natural oil phosphate salt. The base may comprise an inorganic or organic base. Suitable bases include, but are not limited to, sodium hydroxide, potassium hydroxide, and primary, secondary, and tertiary amines, such as triethylamine, triethanolamine, and pyridine, or combinations thereof. In some embodiments, the resulting neutralized salt may have a pH greater than or equal to 7 and less than or equal to 10. Lower or higher pH levels may also be used in certain situations, for example, pH in the range of 5 to 11, but this may impact the solubility of the composition.

In some embodiments, the reaction may take place in a solvent. In some embodiments, the solvent is biodegradable. When a solvent is used, it can be simply decanted after forming the natural oil phosphate salt. Suitable solvents include, but are not limited to, ketones, esters, ethylene glycol esters, glycol ethers, and alcohols. Notable biodegradable solvent examples include, but are not limited to, methylisobutyl ketone, methyl acetate, ethyl acetate, isopropyl acetate, diethylene glycol monobutyl ether acetate, isopropanol ,ethanol, dimethyl methyl glutarate.

The hydroxyphosphoric ester or neutralized phosphate oil salt may be concentrated to yield 100% solids and diluted at the site of application. The solvent can be water or other a polar solvent.

Alternatively, if the hydroxyphosphoric ester or neutralized phosphate oil salt is not a dried solid, it may be diluted in water or other polar solvent to 50 wt/v % (or other suitable dilution amount), packaged as a liquid, and dosed as needed by the operator. The intent is to reduce the viscosity and make the scale inhibitor easier to flow, aid in dispersing in water for use, and add other benefits. The solvent used for dilution for packaging may be the same or different from the solvent used for on-site dilution. Suitable polar solvents (other than water) include, but are not limited to, ethylene glycol and isopropanol, which may also help with reduction of scale formation and depress the freezing point of fracking fluids, respectively. Other similar solvents may be glycerol and ethanol. A typical dilution may simply render the scale inhibitor free flowing and no longer a gel. The level of solvent might range from 20-80%, and may be in addition to water to make it readily dilutable to the level of 0.0001 wt % to 2 wt %.

In some embodiments, the natural oil phosphate salt is dried, and the dried salt is dissolved in a second solvent. The second solvent can be a polar solvent (for example, those described above), or combinations thereof, including combinations of polar solvents and water.

The scale inhibiting composition may include one or more additional components which are typically used in scale inhibiting compositions. Suitable components include, but are not limited to, corrosion inhibitors, additional scale inhibitors (for example, anionic polyelectrolytes such as in acrylates, polyphosphates, lignosulfonates, citric acid, and tannic acids), emulsifiers, deflocculants, thickeners (for example, xanthan, guar gums, carboxymethylcellulose, and starch), weighting agents, clays (for example, bentonite, barite, and chalk hematite), diesel, pour point depressants, biocides, salts, acids, cleaners, pH buffers, or combinations thereof.

Another aspect is method of reducing scale. In one embodiment, the method comprises: introducing a scale inhibiting composition into an oilfield hydraulic fluid, wherein the scale inhibiting composition comprises a reaction product of an epoxidized natural oil and phosphoric acid, the salt having 3 or more phosphorous ester groups per molecule

In some embodiments, the reaction product is neutralized with a base to form a salt of the reaction product. Suitable bases include those discussed above. In some embodiments, the reaction product is neutralized before it is introduced into the oilfield hydraulic fluid. In other embodiments, one or more of the other components of the hydraulic oilfield fluid comprises a base which neutralizes the reaction product forming the water soluble salt.

The reaction product may be dosed into the pipeline in an amount in the range of 0.0001 wt % to 2 wt % of the oilfield hydraulic fluid to inhibit scale, or 0.0001 wt % to 1.75 wt %, or 0.0001 wt % to 1.50 wt %, or 0.0001 wt % to 1.25 wt %, or 0.0001 wt % to 1.00 wt %, or 0.0001 wt % to 0.75 wt %, or 0.0001 wt % to 0.50 wt %, or 0.0001 wt % to 0.25 wt %, or 0.0001 wt % to 0.10 wt %, or 0.0001 wt % to 0.05 wt %, or 0.0001 wt % to 0.01 wt %, or 0.0001 wt % to 0.005 wt %, or 0.0001 wt % to 0.001 wt %.

The oilfield hydraulic fluid may further comprise one or more of: corrosion inhibitors, additional scale inhibitors, emulsifiers, deflocculants, thickeners, weighting agents, clays, diesel, pour point depressants, biocides, salts, acids, cleaners, pH buffers, or combinations thereof.

### EXAMPLE 1: PREPARATION OF PHOSPHATED SOYBEAN OIL

In a 250 mL round bottom flask, 50 grams of epoxidized soybean oil is charged and dissolved in 45 grams of ethyl acetate, followed by a dropwise addition of 23.21 grams of phosphoric acid (85%). The mixture if heated to 50 ° C. and stirred. The reaction was monitored using epoxy value titrations to a value less than 0.5%. The reaction mixture was cooled to room temperature, washed twice with brine, and concentrated under reduced pressure to yield a thick, sticky solid. The product was neutralized with sodium hydroxide to obtain a water-soluble product. The product was most soluble and clear when the pH was greater than 7

### EXAMPLE 2: CALCIUM PRECIPITATION TEST

This procedure was adapted from NACE method TM0374-2016. To a 50:50 calcium (3027 mg/L) : sulfate brine (7207 mg/L) solution, 0.6 μL of a 1 wt % scale inhibitor formula was added. The mixture was heated to 71° C. for 18 hours. Satisfactory samples were identified by greater than 90% calcium inhibition.

The titration method was based off of Calcium (Titrimetric, EDTA) EPA-NERL, The calcium ion is sequestered upon the addition of disodium dihydrogen ethylenediamine tetraacetate (EDTA). The titration end point was detected by means of an murexide indicator which complexes with calcium.

Dynamic scale loop testing showed that at 500 ppm loading of scale inhibitor, the pressure did not build up on sample 7 (phosphated soybean oil) like it did on the incompatible salt solution (Blank). Scale inhibitor V3 and V6 were organophosphate modified soy and phosphate modified soy methyl ester. Scale inhibitor V8 was an organic acid functional soybean oil. Scale inhibitors V3 and V6 having lower degrees of free acid per molecule did not perform as well in this test as the phosphated soybean oil V7. This is attributed to the fact that their functionality per molecule is lower on average. A high functionality provides an inhibitory effect over time, and for use in threshold levels the scale inhibitor should have high functionality.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of reducing scale comprising:
introducing a scale inhibiting composition into an oilfield hydraulic fluid, wherein the scale inhibiting composition comprises:
a reaction product of an epoxidized natural oil and phosphoric acid, the reaction product having 3 or more phosphorous ester groups per molecule.

2. The method of claim 1 further comprising:
neutralizing the reaction product to form a salt of the reaction product.

3. The method of claim 2 wherein a counterion of the salt comprises sodium, potassium, a primary amine, a secondary amine, a tertiary amine, or combinations thereof.

4. The method of claim 2 wherein the reaction product is neutralized before the scale inhibiting composition is introduced into the oilfield hydraulic fluid, and wherein the neutralized reaction product is water soluble.

5. The method of claim 1 wherein the reaction product comprises 0.0001 wt % to 2 wt % of the oilfield hydraulic fluid.

6. The method of claim 1 wherein the oilfield hydraulic fluid further comprises:
a corrosion inhibitor, an additional scale inhibitor, an emulsifier, a deflocculant, a thickener, a weighting agent, a clay, diesel, a pour point depressant, a biocide, a salt, an acid, a cleaner, a pH buffer, or combinations thereof.

7. The method of claim 1 wherein the reaction product is diluted with a polar solvent, before being introduced into the oilfield hydraulic fluid.

8. A method of making a scale inhibiting composition comprising:
reacting an epoxidized natural oil having an oxirane oxygen value in a range of 1 to 10% with phosphoric acid to form a hydroxyphosphoric ester.

9. The method of claim 8 further comprising:
neutralizing the hydroxyphosphoric ester with a base to form a natural oil phosphate salt.

10. The method of claim 9 wherein a counterion of the natural oil phosphate salt comprises sodium, potassium, a primary amine, a secondary amine, a tertiary amine, or combinations thereof.

11. The method of claim 8 wherein the reaction takes place in a solvent.

12. The method of claim 11 wherein the solvent is biodegradable.

13. The method of claim 11 further comprising:
decanting the solvent after forming the hydroxyphosphoric ester.

14. The method of claim 8 further comprising:
diluting the scale inhibiting composition with water.

15. The method of claim 9 further comprising:
drying the natural oil phosphate salt; and
dissolving the dried natural oil salt in a second solvent.

16. The method of claim 15 wherein the second solvent comprises a polar solvent or a combination of polar solvents.

17. A scale inhibiting composition comprising:
a reaction product of an epoxidized natural oil and phosphoric acid, the reaction product having 3 or more phosphorous ester groups per molecule.

18. The composition of claim 17 wherein the reaction product is neutralized forming a salt of the reaction product, and wherein the salt is water-soluble.

19. The composition of claim 18 wherein a counterion of the salt comprises sodium, potassium, primary, secondary, or tertiary amine.

20. The composition of claim 17 wherein the reaction product has 4 or more phosphorous esters per molecule.
